(19) United States
(12) Patent Application Publication
(10) Pub. No.: US 2025/0180113 A1
(43) Pub. Date: Jun. 5, 2025

(54) ROTARY SHIFT DEVICE

(71) Applicant: KABUSHIKI KAISHA TOKAI-RIKA-DENKI-SEISAKUSHO, Aichi (JP)

(72) Inventors: Hironori WATANABE, Niwa-gun, Aichi (JP); Hironori MIZUNO, Niwa-gun, Aichi (JP); Norihiro YAMAMURA, Niwa-gun, Aichi (JP)

(73) Assignee: KABUSHIKI KAISHA TOKAI-RIKA-DENKI-SEISAKUSHO, Aichi (JP)

(21) Appl. No.: 18/843,069

(22) PCT Filed: Feb. 27, 2023
(86) PCT No.: PCT/JP2023/007161

§ 371 Date: Aug. 30, 2024

(30) Foreign Application Priority Data
Mar. 4, 2022 (JP) 2022-033724

(51) Int. Cl. F16H 59/12; F16H 59/08

(52) U.S. Cl. CPC F16H 59/12; F16H 2059/081

(57) ABSTRACT

A rotary shift device includes a rotatable shift selector and a knob button rotatable in conjunction with rotation of the shift selector. By inclusion of the knob button rotatable in conjunction with rotation of the shift selector, the knob button does not need to be formed in a columnar shape so as not to be moved in conjunction with a rotation operation of the shift selector. Therefore, the knob button can have various shapes. As a result, the degree of freedom of the shape of the knob button can be increased.

### TECHNICAL FIELD

The present invention relates to a rotary shift device.

### BACKGROUND ART

A rotary shift device including a rotatable shift selector is known (see, for example, JP 2020-509971 A).

JP 2020-509971 A discloses a rotary shift device in which a rotary knob is rotatably fixed to a housing, the rotary knob is selectively rotatable among a reverse position, a neutral position, and a drive position, and a push button is disposed in the rotary knob.

By the way, in such a rotary shift device, it is preferable to increase the degree of freedom of the shape of an operation unit.

### SUMMARY OF INVENTION

### Technical Problem

In view of the above fact, an object of the present invention is to obtain a rotary shift device capable of increasing the degree of freedom of the shape of an operation unit.

### Solution to Problem

A rotary shift device according to a first aspect of the present invention includes a rotatable shift selector and an operation unit rotatable in conjunction with rotation of the shift selector.

A rotary shift device according to a second aspect of the present invention is the rotary shift device according to the first aspect of the present invention, in which the operation unit is operable at a plurality of rotational positions of the shift selector.

A rotary shift device according to a third aspect of the present invention is the rotary shift device according to the first or second aspect of the present invention, further including an abutting member on which a downstream side of the operation unit in an operation direction abuts, in which an abutting surface of the abutting member is wider than an abutting surface of the operation unit.

A rotary shift device according to a fourth aspect of the present invention is the rotary shift device according to any one of the first to third aspects of the present invention, including a restricting portion that restricts an operation of the operation unit at a predetermined rotational position of the shift selector.

A rotary shift device according to a fifth aspect of the present invention is the rotary shift device according to any one of the first to fourth aspects of the present invention, in which an operation direction of the operation unit is different from a rotation direction of the shift selector.

A rotary shift device according to a sixth aspect of the present invention is the rotary shift device according to any one of the first to fifth aspects of the present invention, in which by operating the operation unit, rotation of the shift selector or movement of a vehicle is restricted or released from restriction.

A rotary shift device according to a seventh aspect of the present invention is the rotary shift device according to any one of the first to fifth aspects of the present invention, in which by operating the operation unit, an instruction of a shift range position corresponding to a rotational position of the shift selector is restricted or released from restriction.

A rotary shift device according to an eighth aspect of the present invention is the rotary shift device according to any one of the first to fifth aspects of the present invention, in which by rotating the shift selector and operating the operation unit, an instruction of a shift range position corresponding to a rotational position of the shift selector is restricted or released from restriction.

### Advantageous Effects of Invention

In the rotary shift device according to the first aspect of the present invention, by inclusion of the operation unit rotatable in conjunction with rotation of the shift selector, the operation unit does not need to be formed in a columnar shape that is not moved in conjunction with a rotation operation of the shift selector. Therefore, the operation unit can have various shapes. As a result, the degree of freedom of the shape of the operation unit can be increased.

In the rotary shift device according to the second aspect of the present invention, the operation unit is operable at a plurality of rotational positions of the shift selector, whereby the operation unit that rotates in conjunction with rotation of the shift selector is operable. Therefore, even when the shift selector is rotating, the operation unit can be operated.

In the rotary shift device according to the third aspect of the present invention, the abutting surface of the abutting member is wider than the abutting surface of the operation unit, whereby the abutting surface of the operation unit abuts on the abutting surface of the abutting member even when the operation unit rotates in conjunction with rotation of the shift selector. Therefore, even when the shift selector rotates, the operation unit can be operable with a simple structure.

In the rotary shift device according to the fourth aspect of the present invention, by inclusion of the restricting portion that restricts an operation of the operation unit at a predetermined rotational position of the shift selector, an operation of the operation unit is restricted at the predetermined rotational position of the shift selector. Therefore, the operation unit can be made inoperable at the predetermined rotational position of the shift selector.

In the rotary shift device according to the fifth aspect of the present invention, the operation direction of the operation unit is different from the rotation direction of the shift selector, whereby the operation unit is operated in a direction different from the rotation direction of the shift selector. Therefore, an erroneous operation in which the operation of the operation unit is erroneously performed as the rotation operation of the shift selector is suppressed.

In the rotary shift device according to the sixth aspect of the present invention, by operating the operation unit, rotation of the shift selector is restricted or released from restriction, whereby the rotation of the shift selector can be restricted or released from restriction by a simple operation. In addition, by operating the operation unit, movement of a vehicle is restricted or released from restriction, whereby the movement of the vehicle can be restricted or released from restriction by a simple operation.

In the rotary shift device according to the seventh aspect of the present invention, by operating the operation unit, an instruction of a shift range position corresponding to a rotational position of the shift selector is restricted or released from restriction, whereby an instruction from the shift selector can be received or not received by a simple operation.

In the rotary shift device according to the eighth aspect of the present invention, by rotating the shift selector and operating the operation unit, an instruction of a shift range position corresponding to a rotational position of the shift selector is restricted or released from restriction, whereby a rotational operation of the shift selector and an operation of the operation unit are simultaneously performed, whereby an instruction from the shift selector can be received or not received. Therefore, it is possible to suppress an erroneous operation of erroneously changing the shift range position.

### BRIEF DESCRIPTION OF DRAWINGS

FIG. 1 is a perspective view illustrating a rotary shift device according to a first embodiment.

FIG. 2 is an exploded perspective view illustrating the rotary shift device according to the first embodiment.

FIG. 3 is a perspective view illustrating a periphery of an operation unit of the rotary shift device according to the first embodiment.

FIG. 4 is a cross-sectional view illustrating the rotary shift device according to the first embodiment, and illustrates a cross section taken along line A-A in FIG. 1.

FIG. 5 is a perspective view illustrating a cover of the rotary shift device according to the first embodiment as viewed from a back surface side.

FIG. 6A is a schematic view schematically illustrating a relationship between an abutting surface of an operation unit and an abutting surface of an abutting member of the rotary shift device according to the first embodiment when viewed from above, and illustrates a state in which a shift range position of a shift selector is at a home position.

FIG. 6B is a schematic view schematically illustrating the relationship between the abutting surface of the operation unit and the abutting surface of the abutting member of the rotary shift device according to the first embodiment when viewed from above, and illustrates a state in which the shift range position of the shift selector is at a reverse position.

FIG. 7 is a cross-sectional view illustrating the rotary shift device according to the first embodiment, and illustrates a state where an operation unit is pressed.

FIG. 8 is a block diagram illustrating a functional configuration of the rotary shift device according to the first embodiment.

FIG. 9 is a flowchart illustrating a flow of an example of a position switching process performed by the rotary shift device according to the first embodiment.

FIG. 10 is a schematic view schematically illustrating a relationship between an abutting surface of an operation unit and an abutting surface of an abutting member of a rotary shift device according to a second embodiment as viewed from above.

### DESCRIPTION OF EMBODIMENTS

### First Embodiment

Hereinafter, a rotary shift device according to a first embodiment will be described with reference to the drawings. In the first embodiment, an example will be described in which a rotary shift device 10 is a biwire type vehicle shift device including a knob button 30 as an operation unit.

Note that, in the drawings, an arrow D indicates a longitudinal direction D of the rotary shift device 10, an arrow E indicates a rotation direction E of a shift selector 20, and an arrow F indicates a rotation direction F of a second magnet 16. In a case where description is simply made using one end side and the other end side, unless otherwise specified, the description is made for the longitudinal direction D of the rotary shift device 10.

### [Structure of Rotary Shift Device]

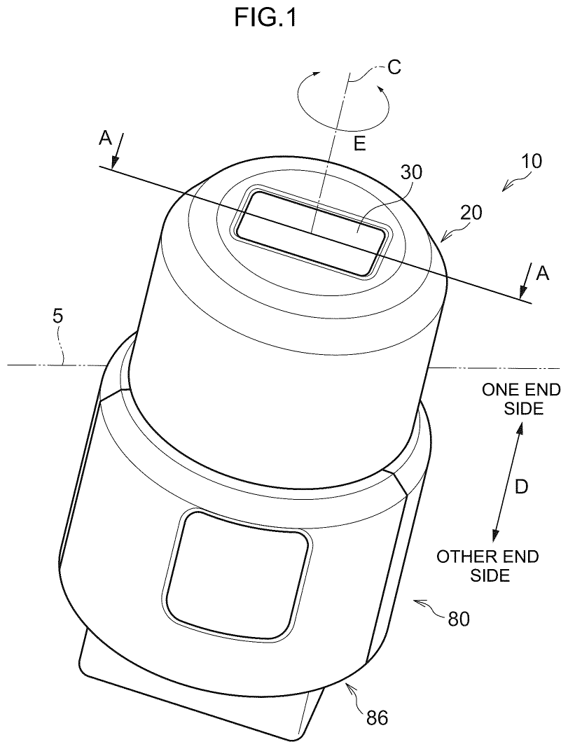

As illustrated in FIG. 1, the rotary shift device 10 according to the first embodiment is disposed, for example, on an instrument panel 5 disposed on a front side in a vehicle interior of a vehicle. By operating the rotary shift device 10, a driver seated on a driver's seat switches among a home position H, a neutral position N, a drive position D, and a reverse position R as shift range positions.

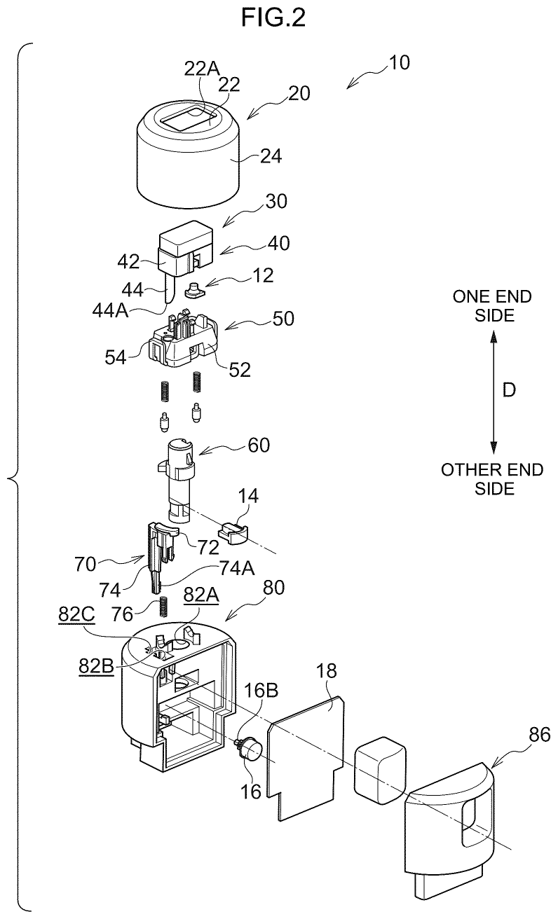

As illustrated in FIGS. 1 and 2, the rotary shift device 10 mainly includes the shift selector 20, a knob button 30 as an operation unit, a pressing member 40 as an operation unit, a support member 50, a rotating member 60, an abutting member 70, a housing 80, an elastic member 12, a first magnet 14, the second magnet 16, and a printed circuit board 18.

### (Shift Selector 20)

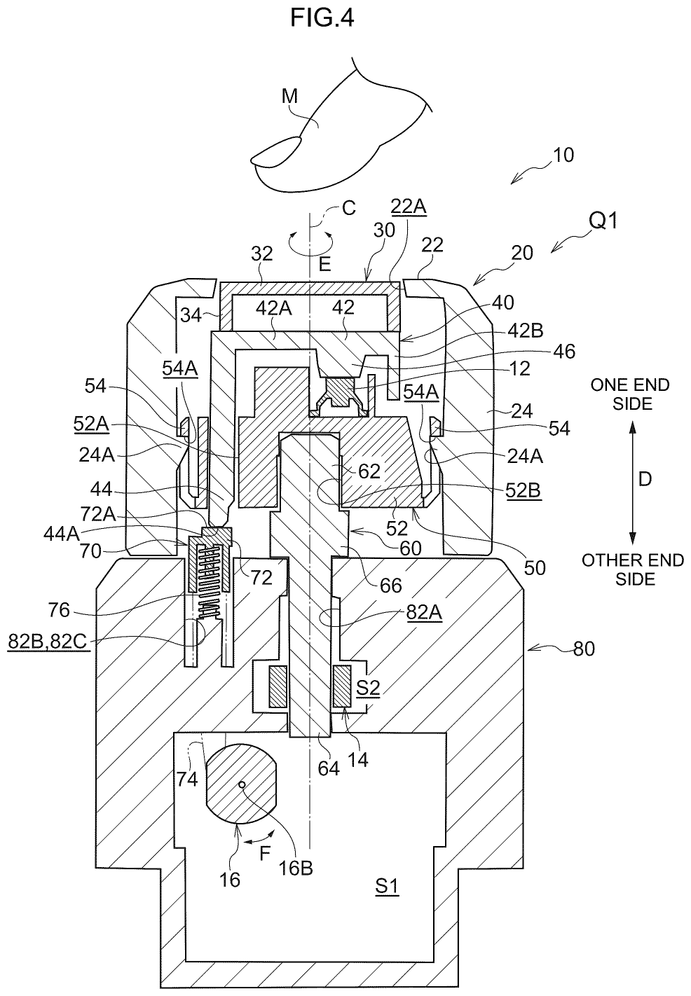

The shift selector 20 is rotatable in the rotation direction E about a central axis C as a rotation center with respect to the housing 80. As illustrated in FIG. 4, the shift selector 20 is formed in a cap shape opened toward the other end side in the longitudinal direction D by a top plate 22 formed in a disk shape and a side wall 24 formed in a cylindrical shape.

The top plate 22 has a rectangular through hole 22A penetrating the top plate 22 in the longitudinal direction D. The inner shape of the through hole 22A is formed to be slightly larger than the outer shape of the knob button 30.

On an inner peripheral surface of the side wall 24, claw portions 24A protruding radially inward are formed at two locations. The claw portion 24A is caught by an opening 54A of an elastic portion 54 disposed in the support member 50, and the shift selector 20 is fixedly attached to the support member 50.

### (Knob Button 30)

The knob button 30 is rotatable in the rotation direction E about the central axis C as a rotation center with respect to the housing 80 and is movable in the longitudinal direction D. As illustrated in FIG. 4, the knob button 30 is formed in a rectangular parallelepiped cap shape opened toward the other end side in the longitudinal direction D by a rectangular plate-shaped top plate 32 and a rectangular tube-shaped side wall 34. The knob button 30 is attached to the pressing member 40 by, for example, a known claw.

The knob button 30 is inserted into the through hole 22A of the top plate 22 of the shift selector 20. As a result, the knob button 30 rotates in conjunction with rotation of the shift selector 20.

### (Pressing Member 40)

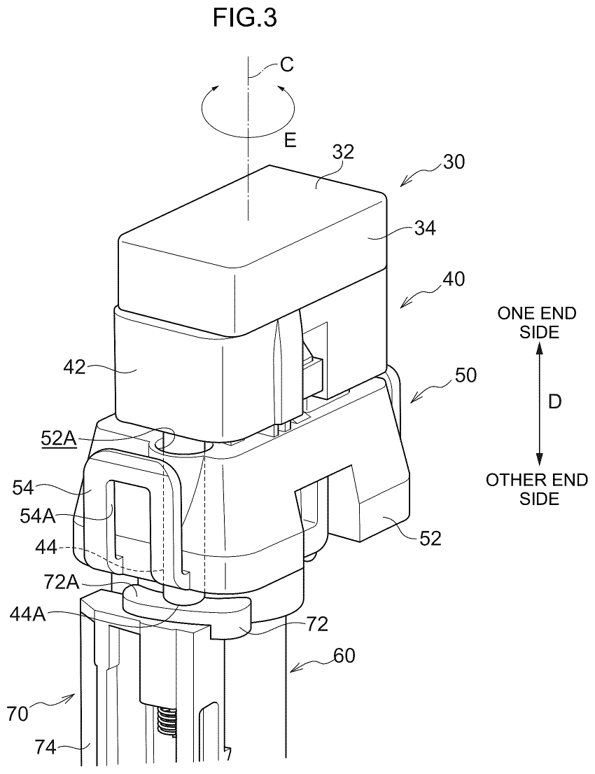

As illustrated in FIGS. 3 and 4, the pressing member 40 is disposed on the other end side of the knob button 30. The pressing member 40 includes a main body portion 42 and a rod-shaped portion 44.

The main body portion 42 is formed in a rectangular box shape opened toward the other end side by a rectangular plate-shaped top plate 42A and a rectangular tube-shaped side wall 42B.

The rod-shaped portion 44 is formed in a columnar shape extending from the main body portion 42 toward the other end side in the longitudinal direction D. The rod-shaped portion 44 penetrates a through hole 52A formed in the support member 50 and abuts on the abutting member 70. A distal end surface 44A on the other end side of the rod-shaped portion 44 constitutes an abutting surface that abuts on an end surface 72A on one end side of the abutting member 70.

The top plate 42A of the main body portion 42 has a protruding portion 46 protruding toward the other end side. A distal end surface of the protruding portion 46 abuts on the elastic member 12.

The elastic member 12 is formed in a cone shape, for example, by rubber. The elastic member 12 applies an elastic force to one end side of the pressing member 40 in the longitudinal direction D via the protruding portion 46.

### (Support Member 50)

As illustrated in FIGS. 3 and 4, the support member 50 includes a main body portion 52 formed in a substantially rectangular parallelepiped shape and an elastic portion 54.

The main body portion 52 has the through hole 52A penetrating the main body portion 52 in the longitudinal direction D and a bottomed hole 52B recessed from the other end side toward one end side of the main body portion 52.

The through hole 52A is formed to have an inner diameter substantially the same as an outer diameter of the rod-shaped portion 44. The rod-shaped portion 44 is inserted into the through hole 52A. The bottomed hole 52B is formed to have an inner diameter substantially the same as an outer diameter of a first end portion 62 on one end side of the rotating member 60. The first end portion 62 is inserted into the bottomed hole 52B, and the support member 50 is fitted to the rotating member 60 so as to be relatively non-rotatable.

The elastic portions 54 are disposed at both end portions of the support member 50 in a longitudinal direction of the support member 50. The elastic portion 54 is formed in a hook shape extending from the other end side toward one end side of the main body portion 52. The elastic portion 54 has an opening 54A penetrating the elastic portion 54 in a thickness direction of the elastic portion 54. The claw portion 24A is caught by the opening 54A, and the shift selector 20 is fixed to the support member 50 so as to be relatively immovable in the longitudinal direction D and the rotation direction E. In other words, the shift selector 20 is fixed to the support member 50.

### (Rotating Member 60)

As illustrated in FIGS. 2 and 4, the rotating member 60 is formed in a substantially columnar shape extending in the longitudinal direction D. The rotating member 60 includes the first end portion 62 on one end side, a second end portion 64 on the other end side, and an intermediate portion 66 between the first end portion 62 and the second end portion 64.

The first end portion 62 is fitted to the bottomed hole 52B of the support member 50. The intermediate portion 66 has an outer diameter larger than the first end portion 62 and the second end portion 64.

The second end portion 64 is inserted into a through hole 82A formed in the housing 80. An end surface of the intermediate portion 66 on the other end side abuts on an end surface of the housing 80 on one end side. The rotating member 60 is disposed to be rotatable about the central axis C as a rotation axis in the rotation direction E with respect to the housing 80.

The first magnet 14 is fixedly attached to the second end portion 64. When the rotating member 60 rotates in the rotation direction E, the first magnet 14 rotates in the rotation direction E about the central axis C as a rotation axis with respect to the housing 80.

### (Abutting Member 70)

As illustrated in FIG. 2, the abutting member 70 is biased toward one end side in the longitudinal direction D by a compression coil spring 76 disposed between the abutting member 70 and the housing 80. The abutting member 70 includes an extending portion 74 extending in the longitudinal direction D and an abutting portion 72 formed on one end side of the extending portion 74. As illustrated in FIG. 3, an end surface 72A of the abutting portion 72 on one end side constitutes an abutting surface abutting on a distal end surface 44A of the rod-shaped portion 44. In other words, the distal end surface 44A of the rod-shaped portion 44 on the other end side abuts on the end surface 72A of the abutting member 70 in an operation direction (pressing direction) of the knob button 30.

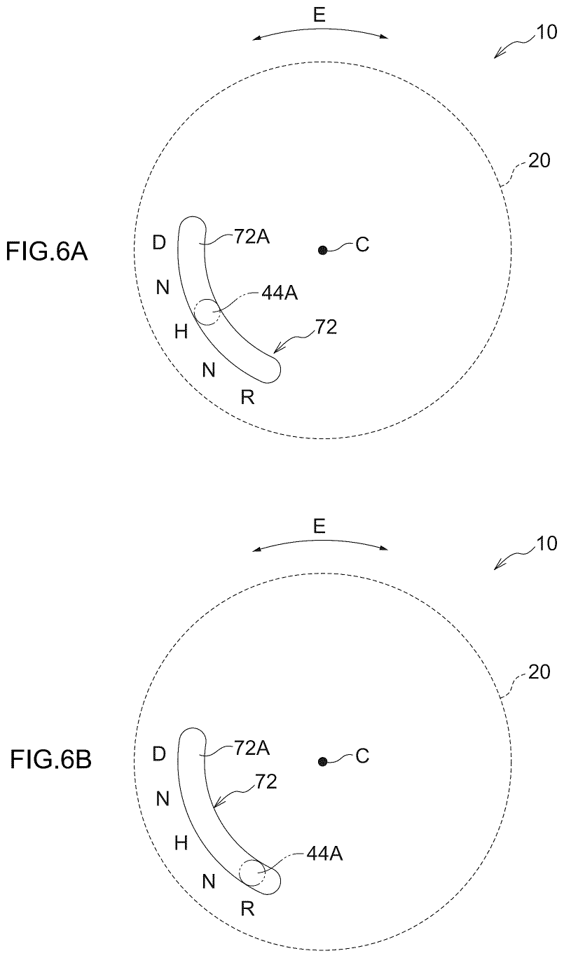

As illustrated in FIG. 6A, in a cross section perpendicular to the central axis C, the end surface 72A is formed in an arc-shaped belt shape centered on the central axis C. The radial width of the end surface 72A is formed to be larger than that of the distal end surface 44A of the rod-shaped portion 44. The length of the end surface 72A in the rotation direction E is formed to be longer than that of the distal end surface 44A of the rod-shaped portion 44.

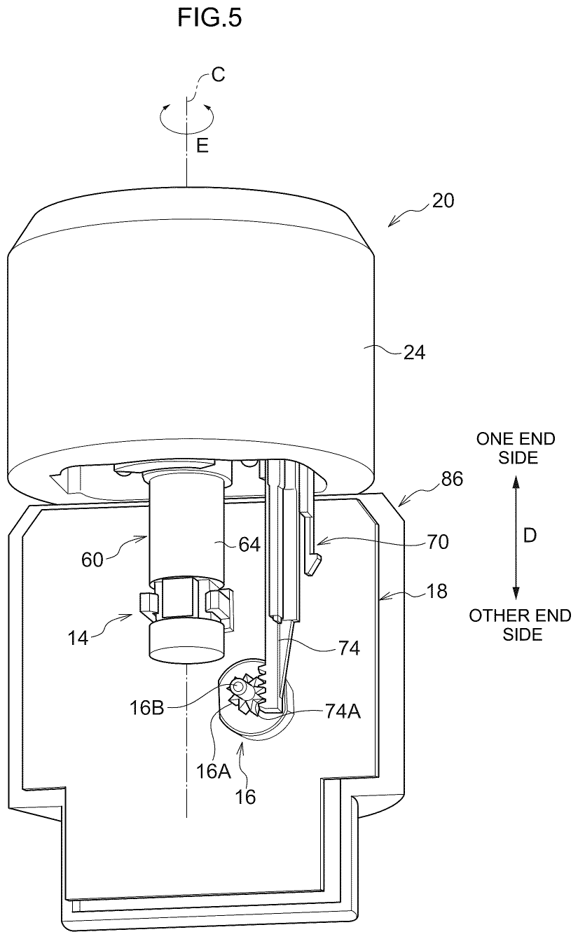

As illustrated in FIG. 5, a rack 74A meshing with a pinion 16A of the second magnet 16 is formed on the other end side of the extending portion 74.

### (Housing 80)

As illustrated in FIGS. 2 and 4, the housing 80 is disposed on the other end side of the shift selector 20 and is formed in a substantially columnar shape. The housing 80 is fixed to the instrument panel 5. The outer diameter of the housing 80 is formed to be larger than that of the shift selector 20. The housing 80 has a bottomed hole 82B recessed from an end surface on one end side to the other end side, a through hole 82C formed adjacent to the bottomed hole 82B, and a through hole 82A communicating with a first internal space S1 of the housing 80 in the longitudinal direction D.

The through hole 82A has an inner diameter slightly larger than the outer diameter of the second end portion 64. A second internal space S2 in which the first magnet 14 is rotatably disposed is formed on the other end side of the through hole 82A.

The compression coil spring 76 is disposed in the bottomed hole 82B. The through hole 82C extends in the longitudinal direction D and communicates with the first internal space S1 of the housing 80. The extending portion 74 of the abutting member 70 is inserted into the through hole 82C.

A shaft portion 16B of the second magnet 16 is attached to the housing 80 so as to be rotatable in the rotation direction F.

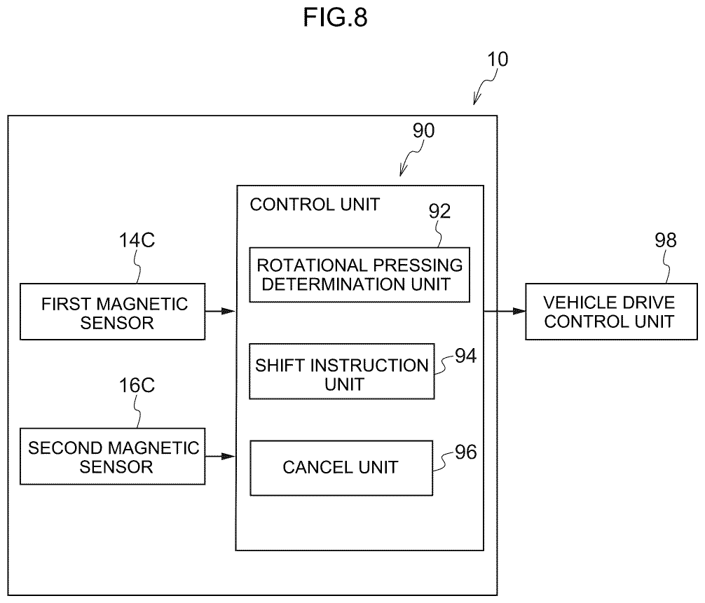

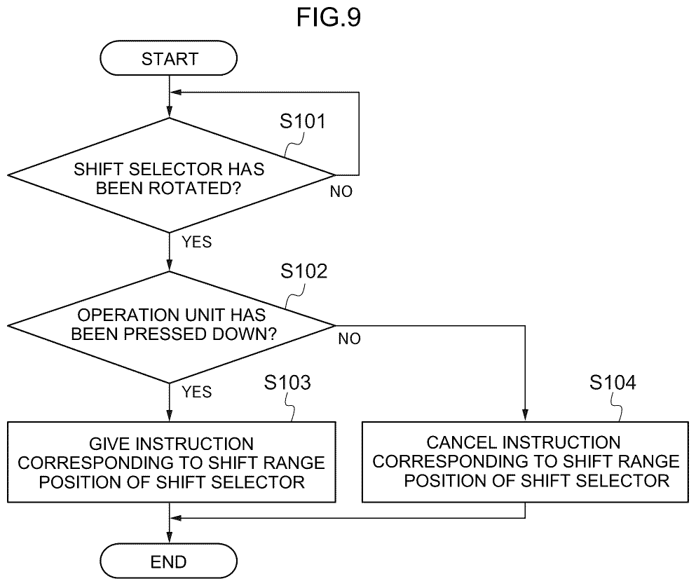

As illustrated in FIGS. 2 and 5, the printed circuit board 18 is attached to the housing 80. The printed circuit board 18 includes a first magnetic sensor 14C (see FIG. 8) that measures a direction of a magnetic field of the first magnet 14 and a second magnetic sensor 16C (see FIG. 8) that measures a direction of a magnetic field of the second magnet 16. A cover 86 is attached to the housing 80 so as to cover the printed circuit board 18 in a state where the printed circuit board 18 is attached to the housing 80.

### [Operation of Rotary Shift Device]

### (Pressing Operation of Knob Button 30)

As illustrated in FIG. 4, before the knob button 30 is pressed down by a finger M, the knob button 30 is at a reference position Q1 lifted to one end side in the longitudinal direction D by an elastic force of the elastic member 12 and a biasing force of the compression coil spring 76.

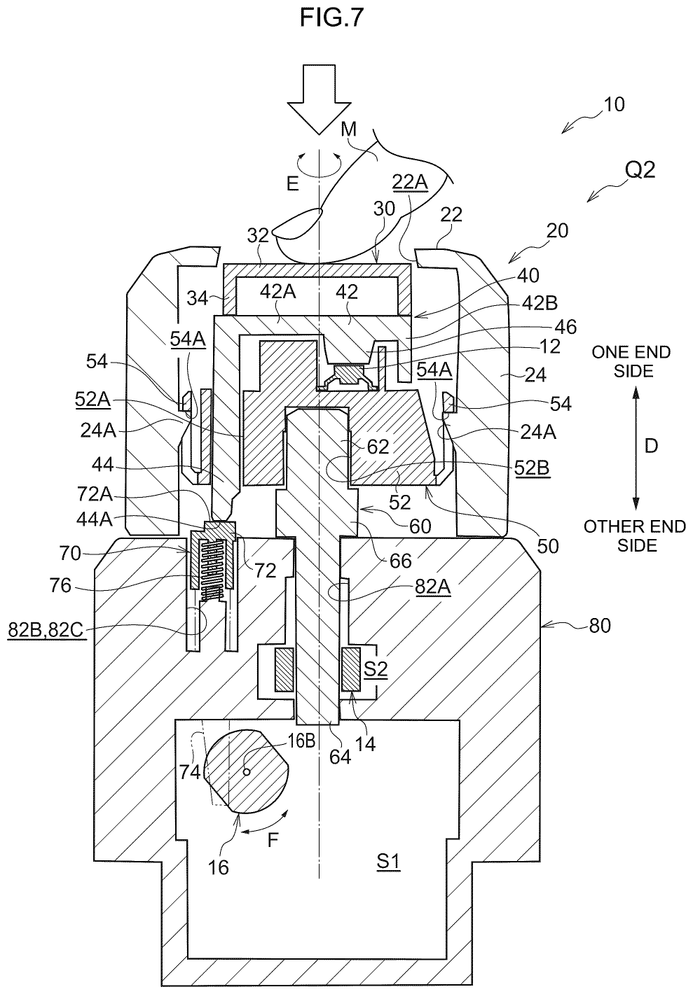

When the knob button 30 is pressed down by the finger M toward the other end side in the longitudinal direction D against the elastic force of the elastic member 12 and the biasing force of the compression coil spring 76, the elastic member 12 and the compression coil spring 76 are compressed as illustrated in FIG. 7. As a result, the knob button 30 and the pressing member 40 are moved to a pressing-down position Q2 moved to the other end side in the longitudinal direction D. Here, the distal end surface 44A of the rod-shaped portion 44 of the pressing member 40 abuts on the end surface 72A of the abutting member 70 on one end side. Therefore, when the knob button 30 and the pressing member 40 are moved to the other end side in the longitudinal direction D, the abutting member 70 is also moved to the other end side in the longitudinal direction D in conjunction with the knob button 30 and the pressing member 40.

When the abutting member 70 is moved to the other end side in the longitudinal direction D, the second magnet 16 is moved in the rotation direction F via the rack 74A and the pinion 16A. The second magnet 16 is moved in the rotation direction F, whereby a direction of a magnetic field detected by the second magnetic sensor 16C changes.

When the finger M is separated from the knob button 30, the knob button 30 is returned to the reference position Q1 lifted to one end side in the longitudinal direction D by the elastic force of the elastic member 12 and the biasing force of the compression coil spring 76. That is, the operation direction of the knob button 30 is different from the rotation direction E of the shift selector 20.

### (Rotation Operation of Shift Selector 20)

When the shift selector 20 is pinched with the finger M and is rotated in the rotation direction E, the support member 50 and the rotating member 60 fixed to the shift selector 20 are rotated about the central axis C axis as a rotation axis as illustrated in FIG. 4.

Here, the rod-shaped portion 44 of the pressing member 40 is inserted into the through hole 52A of the support member 50 having an inner diameter substantially the same as the outer diameter of the rod-shaped portion 44. Therefore, when the support member 50 rotates, the pressing member 40 and the knob button 30 fixed to the pressing member 40 are also rotated in conjunction with the rotation of the support member 50. That is, when the shift selector 20 rotates, the knob button 30 is also rotated in conjunction therewith.

Here, as illustrated in FIG. 6A, in a state where the shift selector 20 is at the home position H, the distal end surface 44A of the rod-shaped portion 44 abuts on the end surface 72A of the abutting member 70. The distal end surface 44A of the rod-shaped portion 44 is formed to be wider than the end surface 72A of the abutting member 70. Therefore, as illustrated in FIG. 6B, even when the shift selector 20 is rotated and moved from the home position H to the reverse position R, the distal end surface 44A of the rod-shaped portion 44 maintains a state of abutting on the end surface 72A of the abutting member 70. In addition, even when the shift selector 20 is rotated and moved from the home position H to the neutral position N or the drive position D, the distal end surface 44A of the rod-shaped portion 44 maintains a state of abutting on the end surface 72A of the abutting member 70.

As a result, the knob button 30 can be pressed at a plurality of rotational positions of the shift selector 20.

When the shift selector 20 rotates to rotate the rotating member 60, the first magnet 14 fixed to the rotating member 60 rotates in the rotation direction E about the central axis C as a rotation axis. When the first magnet 14 is moved in the rotation direction E, a direction of a magnetic field detected by the first magnetic sensor 14C changes.

### [Functional Configuration of Rotary Shift Device]

As illustrated in FIG. 8, the rotary shift device 10 has such a function that detection information of the first magnetic sensor 14C and detection information of the second magnetic sensor 16C are input to the control unit 90, and information processed by a control unit 90 is output to a vehicle drive control unit 98.

The first magnetic sensor 14C detects a direction of a magnetic field from the first magnet 14. Detection information detected by the first magnetic sensor 14C is input to the control unit 90. The second magnetic sensor 16C detects a direction of a magnetic field from the second magnet 16. Detection information detected by the second magnetic sensor 16C is input to the control unit 90.

The control unit 90 includes a rotational pressing determination unit 92, a shift instruction unit 94, and a cancel unit 96.

The rotational pressing determination unit 92 determines rotation of the shift selector 20 on the basis of detection information detected by the first magnetic sensor 14C. Specifically, the rotational pressing determination unit 92 determines whether the shift selector 20 is at the home position H, the neutral position N, the drive position D, or the reverse position R on the basis of the detection information detected by the first magnetic sensor 14C.

The rotational pressing determination unit 92 determines pressing of the knob button 30 on the basis of detection information detected by the second magnetic sensor 16C. Specifically, the rotational pressing determination unit 92 determines whether the knob button 30 is at the reference position Q1 or the pressing-down position Q2 on the basis of the detection information detected by the second magnetic sensor 16C.

The shift instruction unit 94 gives an instruction corresponding to a shift range position of the shift selector 20 to the vehicle drive control unit 98. Specifically, when the shift selector 20 is, for example, at the drive position D, the shift instruction unit 94 gives an instruction corresponding to the drive position D to the vehicle drive control unit 98. When the shift selector 20 is, for example, at the reverse position R, the shift instruction unit 94 gives an instruction corresponding to the reverse position R to the vehicle drive control unit 98.

The cancel unit 96 cancels an instruction to be given by the shift instruction unit 94 to the vehicle drive control unit 98 on the basis of determination information of the rotational pressing determination unit 92. Specifically, for example, when the rotational pressing determination unit 92 determines that the shift selector 20 is rotated from the neutral position N to the reverse position R and determines that the knob button 30 is at the reference position Q1, the cancel unit 96 cancels an instruction to be given by the shift instruction unit 94 to the vehicle drive control unit 98.

The vehicle drive control unit 98 controls drive of the vehicle on the basis of instruction information of the shift instruction unit 94, cancellation information of the cancel unit 96, and information on an accelerator pedal stepping amount.

### [Flow of Position Switching Process by Rotary Shift Device]

As an example of a flow of a position switching process by the rotary shift device 10, a case where the neutral position N is switched to the reverse position R will be described.

As illustrated in FIG. 6, when a position switching process is started, the rotational pressing determination unit 92 determines whether or not the shift selector 20 has been rotated from the neutral position N to the reverse position R (step S101).

If it is determined that the shift selector 20 has not been rotated from the neutral position N to the reverse position R (NO in step S101), the process returns to step S101. On the other hand, if it is determined that the shift selector 20 has been rotated from the neutral position N to the reverse position R (YES in step S101), the rotational pressing determination unit 92 determines whether or not the knob button 30 has been pressed (step S102).

If it is determined that the knob button 30 has been pressed (YES in step S102), the process proceeds to step S103.

In step S103, the shift instruction unit 94 gives an instruction corresponding to the reverse position R of the shift selector 20 to the vehicle drive control unit 98 (step S103), and the position switching process is ended.

On the other hand, if it is determined that the knob button 30 has not been pressed (NO in step S102), the process proceeds to step S104.

In step S104, the cancel unit 96 gives an instruction to cancel the instruction corresponding to the reverse position R of the shift selector 20 to the vehicle drive control unit 98 (step S104), and the position switching process is ended.

That is, by operating the knob button 30, the instruction of a shift range position corresponding to a rotational position of the shift selector 20 is released from restriction. In addition, by rotating the shift selector 20 and pressing down the knob button 30, the instruction of a shift range position corresponding to a rotational position of the shift selector 20 is released from restriction.

### Effect of First Embodiment

The rotary shift device 10 of the first embodiment includes the rotatable shift selector 20 and the knob button 30 rotatable in conjunction with rotation of the shift selector 20 (see FIG. 2).

By the way, in a conventional rotary shift device, a knob button is formed in a columnar shape that is not moved in conjunction with a rotation operation of a shift selector. As a result, the shift selector and the knob button are operable independently of each other. Therefore, the knob button has a problem that the degree of freedom in shape is reduced.

In the first embodiment, by inclusion of the knob button 30 rotatable in conjunction with rotation of the shift selector 20, the knob button 30 does not need to be formed in a columnar shape that is not moved in conjunction with a rotation operation of the shift selector 20. Therefore, the knob button 30 can have various shapes. As a result, the degree of freedom of the shape of the knob button 30 can be increased.

In the rotary shift device 10 of the first embodiment, the knob button 30 is operable at a plurality of rotational positions of the shift selector 20 (see FIG. 6A).

The knob button 30 is operable at a plurality of rotational positions of the shift selector 20, whereby the knob button 30 that rotates in conjunction with rotation of the shift selector 20 is operable. Therefore, even when the shift selector 20 is rotating, the knob button 30 can be operated.

The rotary shift device 10 of the first embodiment includes the abutting member 70 on which a downstream side of the knob button 30 in an operation direction of the knob button 30 abuts, and the end surface 72A of the abutting member 70 is wider than the distal end surface 44A of the pressing member 40 to which the knob button 30 is attached (see FIG. 6A).

Since the end surface 72A of the abutting member 70 is wider than the distal end surface 44A of the pressing member 40 to which the knob button 30 is attached, even when the knob button 30 rotates in conjunction with rotation of the shift selector 20, the distal end surface 44A of the pressing member 40 abuts on the end surface 72A of the abutting member 70. Therefore, even when the shift selector 20 rotates, the knob button 30 can be operable with a simple structure.

In the rotary shift device 10 of the first embodiment, an operation direction of the knob button 30 is different from the rotation direction E of the shift selector 20.

The operation direction of the knob button 30 is different from the rotation direction E of the shift selector 20, whereby the knob button 30 is operated in a direction different from the rotation direction E of the shift selector 20. Therefore, an erroneous operation in which the operation of the knob button 30 is erroneously performed as the rotation operation of the shift selector 20 is suppressed.

In the rotary shift device 10 of the first embodiment, by operating the knob button 30, an instruction of a shift range position corresponding to a rotational position of the shift selector 20 is released from restriction.

By operating the knob button 30, an instruction of a shift range position corresponding to a rotational position of the shift selector 20 is released from restriction, whereby an instruction from the shift selector 20 can be received or not received by a simple operation.

In the rotary shift device 10 of the first embodiment, by rotating the shift selector 20 and pressing down the knob button 30, an instruction of a shift range position corresponding to a rotational position of the shift selector 20 is released from restriction.

By rotating the shift selector 20 and pressing down the knob button 30, an instruction of a shift range position corresponding to a rotational position of the shift selector 20 is released from restriction. Therefore, a rotation operation of the shift selector 20 and an operation of the knob button 30 are simultaneously performed, whereby an instruction from the shift selector 20 can be received. Therefore, for example, when the shift position is switched from the neutral position N to the reverse position R, a rotation operation of the shift selector 20 and an operation of the knob button 30 are simultaneously performed, whereby a shift lock can be released. As a result, it is possible to suppress an erroneous operation of erroneously changing a shift range position.

### Second Embodiment

A rotary shift device of a second embodiment is different from the rotary shift device of the first embodiment in that a restricting portion that restricts movement of a pressing member is disposed.

Hereinafter, a structure of the rotary shift device of the second embodiment will be described. Note that the same parts as or equivalent parts to those described in the first embodiment will be described using the same terms or reference numerals.

### [Structure of Rotary Shift Device]

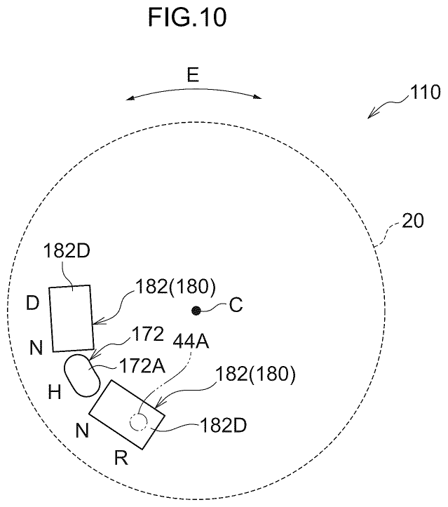

In the second embodiment, as illustrated in FIG. 10, a housing 180 includes a protrusion 182 as a restricting portion protruding from an end surface on one end side toward one end side. An end surface 182D of the protrusion 182 on one end side is formed at the same position in a longitudinal direction D as an end surface 172A of an abutting portion 172 when a knob button 30 is at a reference position Q1. The end surface 172A of the abutting portion 172 is disposed at a position corresponding to a home position H. The end surface 182D of the protrusion 182 is disposed at a position corresponding to a neutral position N, a drive position D, or a reverse position R.

The areas of the end surface 172A and the end surface 182D are formed to be larger than that of a distal end surface 44A of a rod-shaped portion 44.

### [Operation of Rotary Shift Device]

As illustrated in FIG. 10, when a shift selector 20 is rotated and moved from the home position H to the neutral position N, the drive position D, or the reverse position R, the distal end surface 44A of the rod-shaped portion 44 abuts on the end surface 182D of the protrusion 182. As a result, a pressing operation of the knob button 30 is restricted.

### Effect of Second Embodiment

A rotary shift device 110 of the second embodiment has the protrusion 182 that restricts an operation of the knob button 30 at a predetermined rotational position of the shift selector 20.

By inclusion of the protrusion 182 that restricts an operation of the knob button 30 at a predetermined rotational position of the shift selector 20, the operation of the knob button 30 is restricted at the predetermined rotational position of the shift selector 20. Therefore, the knob button 30 can be made inoperable at the predetermined rotational position of the shift selector 20.

Note that other structures and effects are substantially similar to those of the first embodiment, and thus description thereof will be omitted.

The rotary shift device of the present invention has been described above on the basis of the first embodiment and the second embodiment. However, specific structures are not limited to these embodiments, and design changes and the like are allowed without departing from the gist of the invention according to claims.

In the first embodiment and the second embodiment, an example has been described in which by rotating the shift selector 20 and pressing down the knob button 30, an instruction of a shift range position corresponding to a rotational position of the shift selector 20 is released from restriction. However, by rotating the shift selector 20 and pressing down the knob button 30, an instruction of a shift range position corresponding to a rotational position of the shift selector 20 may be restricted. In addition, by simply operating the knob button 30 without rotating the shift selector 20, an instruction of a shift range position corresponding to a rotational position of the shift selector 20 may be restricted or released from restriction.

In addition, by operating the knob button 30, rotation of the shift selector 20 may be mechanically restricted or released from restriction. As a result, the rotation of the shift selector can be restricted or released from restriction by a simple operation. In addition, by operating the knob button 30, movement of the vehicle may be restricted or released from restriction. As a result, movement of a vehicle can be restricted or released from restriction by a simple operation.

In the first embodiment and the second embodiment, an example has been described in which by rotating the shift selector 20 and pressing down the knob button 30, an instruction of a shift range position corresponding to a rotational position of the shift selector 20 is released from restriction. However, by rotating the shift selector 20 while pressing down the knob button 30, an instruction of a shift range position corresponding to a rotational position of the shift selector 20 may be restricted or released from restriction. In addition, by pressing down the knob button 30 and then rotating the shift selector 20, an instruction of a shift range position corresponding to a rotational position of the shift selector 20 may be restricted or released from restriction.

In the first embodiment and the second embodiment, an example has been described in which a magnetic sensor is used as a sensor that detects rotation of the shift selector 20 and pressing down of the knob button 30. However, the sensor is not limited to the magnetic sensor, and another sensor can be used.

In the first embodiment and the second embodiment, an example has been described in which the knob button 30 is formed in a rectangular parallelepiped cap shape. However, the knob button 30 can have a cap shape such as a polygonal column or an elliptic column (including a columnar shape).

In the first embodiment and the second embodiment, an example has been described in which the operation unit is the knob button 30. However, the operation unit can be a parking switch (P switch), a neutral switch (N switch), or another switch.

For example, in a case where the operation unit is a P switch, when the P switch is pressed down while the shift selector 20 is at the home position H, an instruction of a parking position may be given. In this case, when the P switch is pressed down while the shift selector 20 is at a shift range position other than the home position H, an instruction of a parking position does not have to be given.

In the second embodiment, an example has been described in which the restricting portion is disposed in the housing 180. However, the restricting portion is not limited to this mode, and may be disposed on a cover, for example.

In the first embodiment and the second embodiment, an example has been described in which the rotary shift device 10 is disposed on the instrument panel 5. However, the rotary shift device can be disposed on a console, a floor, a door trim, or another component in the vehicle interior.

The whole of the disclosure of Japanese Patent Application No. 2022-33724 filed on Mar. 4, 2022 is incorporated herein by reference.

### Reference Signs List

10 Rotary shift device
20 Shift selector
30 Knob button (example of operation unit)
70 Abutting member
72A Abutting surface
40 Pressing member
44A Abutting surface
180 Protrusion (example of restricting portion)

1. A rotary shift device comprising:
a rotatable shift selector; and
an operation unit rotatable in conjunction with rotation of the shift selector.

2. The rotary shift device according to claim 1, wherein the operation unit is operable at a plurality of rotational positions of the shift selector.

3. The rotary shift device according to claim 1, further comprising an abutting member on which a downstream side of the operation unit in an operation direction abuts, wherein an abutting surface of the abutting member is wider than an abutting surface of the operation unit.

4. The rotary shift device according to claim 1, comprising a restricting portion that restricts an operation of the operation unit at a predetermined rotational position of the shift selector.

5. The rotary shift device according to claim 1, wherein an operation direction of the operation unit is different from a rotation direction of the shift selector.

6. The rotary shift device according to claim 1, wherein, by operating the operation unit, rotation of the shift selector or movement of a vehicle is restricted or released from restriction.

7. The rotary shift device according to claim 1, wherein, by operating the operation unit, an instruction of a shift range position corresponding to a rotational position of the shift selector is restricted or released from restriction.

8. The rotary shift device according to claim 1, wherein, by rotating the shift selector and operating the operation unit, an instruction of a shift range position corresponding to a rotational position of the shift selector is restricted or released from restriction.

9. The rotary shift device according to claim 1, wherein, by rotating the shift selector while operating the operation unit, an instruction of a shift range position corresponding to a rotational position of the shift selector is restricted or released from restriction.

10. The rotary shift device according to claim 1, wherein, by operating the operation unit and then rotating the shift selector, an instruction of a shift range position corresponding to a rotational position of the shift selector is restricted or released from restriction.
